(19) United States
(12) Patent Application Publication
(10) Pub. No.: US 2022/0122106 A1
(43) Pub. Date: Apr. 21, 2022

(54) SYSTEMS AND METHODS FOR IDENTIFYING MEDIA CONSUMPTION MARKETS

(71) Applicant: Comscore, Inc., Reston, VA (US)

(72) Inventors: Rebecca MILLER, Portland, OR (US); Erica FRISCH, Portland, OR (US); Kristi WALKER, Portland, OR (US); Joseph R. RUTHRUFF, Portland, OR (US); Michael J. VINSON, Oakland, CA (US)

(21) Appl. No.: 16/949,225

(22) Filed: Oct. 20, 2020

(51) Int. Cl. G06Q 30/02; G06Q 10/10; H04N 21/45; H04N 21/81

(52) U.S. Cl. CPC G06Q 30/0205; G06Q 10/10; H04N 21/4532; H04N 21/812; H04N 21/4524

(57) ABSTRACT

Geographic identifiers and television network affiliate data may be received. A primary local affiliate station for each of the plurality of national television networks may be determined for each geographic identifier. The geographic identifiers that have the same primary local affiliate for each of the plurality of national television networks may be grouped together to form a first plurality of markets. The markets from the first plurality of markets that have the same primary local affiliate for a first subset of the plurality of national television networks may be merged together, resulting in a second, smaller plurality of markets. Each of the geographic identifiers may be assigned to a market from the second plurality of markets, and a report indicating the second plurality of markets may be output.

### BACKGROUND

National media programming and advertising may be seen by all consumers of a media segment across a nation, regardless of the consumers' local geographic locations. However, a significant portion of media programming and advertising may only be available to consumers located in certain local geographic regions. It may be difficult to identify and define the geographic boundaries of media consumption due to the varying availability of local media programming and advertising. Therefore, improvements in media consumption boundary techniques are needed.

### SUMMARY

Methods and systems are disclosed for identifying media consumption markets. Geographic identifiers, each indicating a geographic area, may be received. Television network affiliate data indicating local affiliate stations for a plurality of national television networks may also be received. For each geographic identifier, a primary local affiliate station for each of the plurality of national television networks may be determined. The geographic identifiers that have the same primary local affiliate for each of the plurality of national television networks may be grouped together to generate a first plurality of markets. If it is determined that at least two markets from the first plurality of markets have the same primary local affiliate for a first subset of the plurality of national television networks, the markets may be merged together to generate a second, smaller plurality of markets. Each of the geographic identifiers may be assigned to a market from the second plurality of markets, and a report indicating the second plurality of markets may be output.

If it is determined that at least two markets from the second plurality of markets have the same primary local affiliate for a second subset of the plurality of national television networks, the second subset being smaller than the first subset, the markets from the second plurality of markets may be merged together to generate a third, even smaller plurality of markets. The markets may be merged together to generate the third plurality of markets if it is determined that the markets satisfy a population threshold or a geographic identifier threshold. Each of the geographic identifiers may be assigned to a market from the third plurality of markets, and a report indicating the third plurality of markets may be output.

If it is determined that a county is associated with a first geographic identifier assigned to a first market from the third plurality of markets and a second geographic identifier assigned to a second market from the third plurality of markets, either the first geographic identifier or the second geographic identifier needs to be reassigned. Population data associated with the first geographic identifier may be compared to population data associated with the second geographic identifier. If it is determined that the second geographic identifier is associated with a greater number of households or a greater number of people than the first geographic identifier, the first geographic identifier may be reassigned to the second market. Conversely, if it is determined that the first geographic identifier is associated with a greater number of households or a greater number of people than the second geographic identifier, the second geographic identifier may be reassigned to the first market.

### BRIEF DESCRIPTION OF THE DRAWINGS

The accompanying drawings, which are incorporated in and constitute a part of this specification, illustrate embodiments and together with the description, serve to explain the principles of the methods and systems:

FIGS. 1A-D illustrates various media consumption markets associated with a geographic area according to an embodiment of the present disclosure;

FIG. 2 illustrates a block diagram of an example environment according to an embodiment of the present disclosure;

FIGS. 3A-E illustrate flow charts of example methods according to embodiments of the present disclosure;

FIG. 4 illustrates a block diagram of an example computing device according to an embodiment of the present disclosure.

### DETAILED DESCRIPTION OF ILLUSTRATIVE EMBODIMENTS

A television network distributes television program content to consumers. A television network may, for example, distribute national programming to all consumers in a nation. Major television networks may include the National Broadcast Company (NBC), CBS, the American Broadcasting Company (ABC), and the Fox Broadcasting Company (Fox). A network affiliate or an affiliated station is a local broadcaster owned by a company other than the television network. The network affiliate carries some or all of the lineup of the television programs of the television network. Each major television network may have zero, one, or multiple affiliate stations in a particular local geographic region. For example, a local geographic region defined by the ZIP code 97220 may have the Portland KATU ABC affiliate, the Portland KOIN CBS affiliate, and the Portland KGW NBC affiliate, amongst others.

It may be difficult to identify and define the geographic boundaries associated with local media consumption. In some cases, a particular local geographic region, such as a region defined by a particular ZIP code, may have one or more of the same network affiliates as its neighboring local geographic region, such as a region defined by a different ZIP code. For example, two neighboring local geographic regions may have the same NBC and ABC affiliate stations. In another example, the two neighboring local geographic regions may only have the same FOX affiliate station. In other cases, a particular local geographic region may share no network affiliates with its neighboring local geographic region. For example, two neighboring local geographic regions may have different NBC, FOX, ABC, and CBS affiliate stations. Additionally, a particular local geographic region may have one or more of the same network affiliates as a non-neighboring local geographic region. This varying availability of local television programming makes it difficult to identify and define the geographic media consumption boundaries.

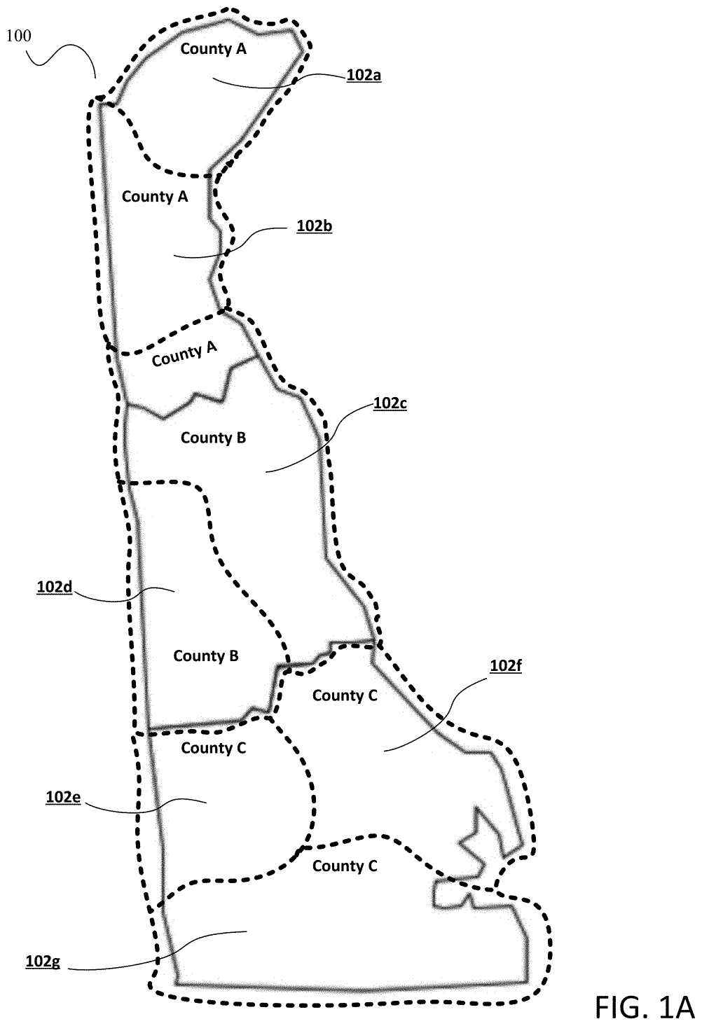

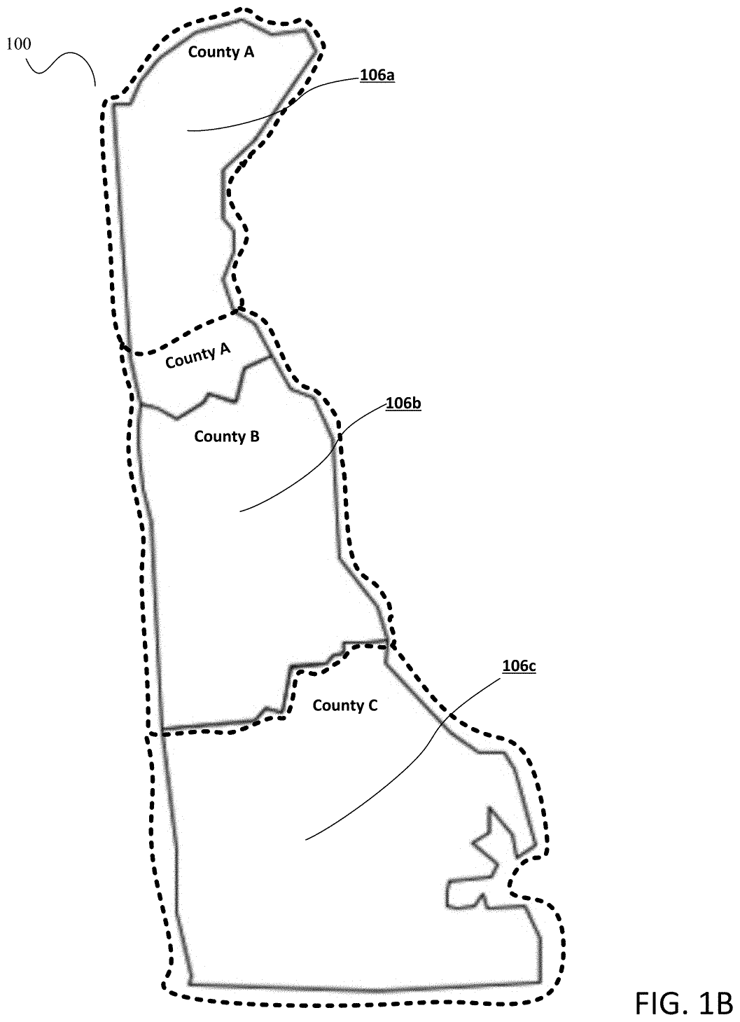

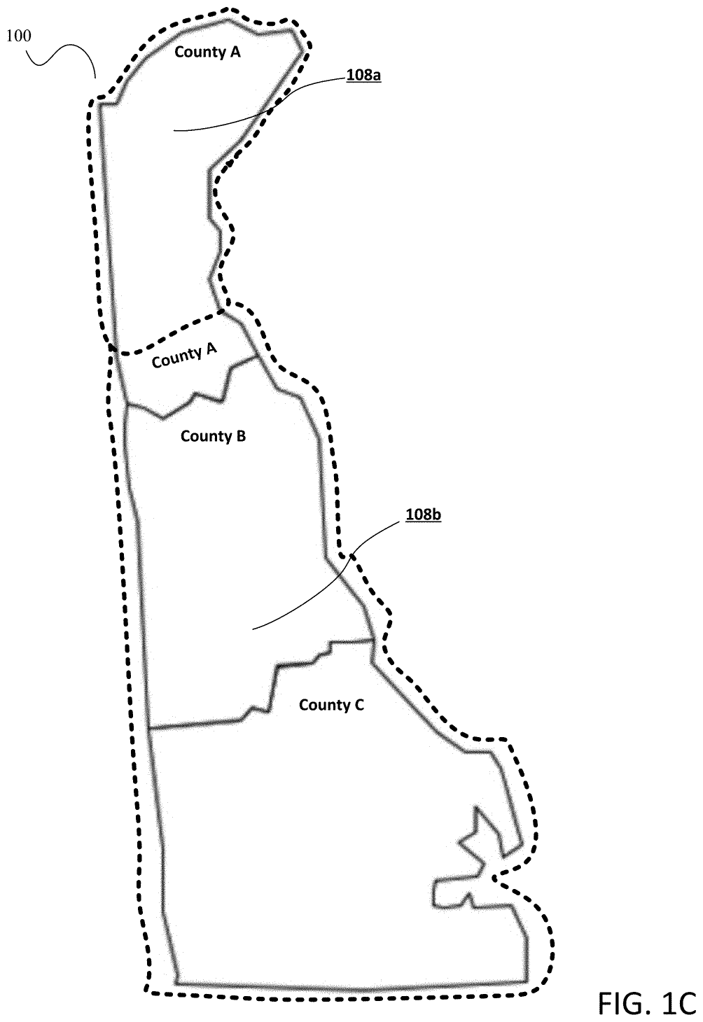

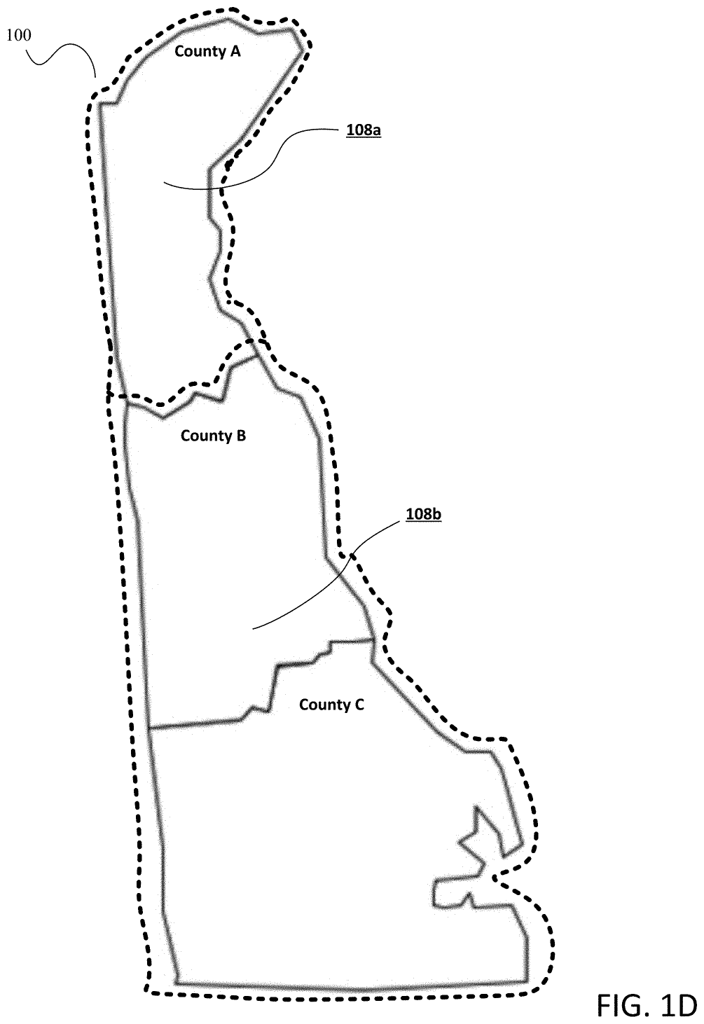

To identify and define the geographic boundaries associated with local media consumption, local geographic areas may be grouped into different markets. FIGS. 1A-D illustrate exemplary media consumption markets. In each of FIGS. 1A-D, a geographic region 100 has been grouped into exemplary media consumption markets. For example, the geographic region 100 may be a state or another type of municipality. The geographic region 100 may contain more than one county, such as “County A,” “County B,” and “County C.” The geographic region 100 may be associated with a plurality of geographic identifiers, with each of the plurality of geographic identifiers indicating a local geographic area within the region 100. For example, the geographic identifiers may be ZIP codes, area codes, latitude-longitude values, city names, neighborhood names, county names, or census designated places. The media consumption markets in each of FIGS. 1A-D are indicated by dashed lines. Each of the geographic identifiers may belong to at least one media consumption market.

FIG. 1A illustrates the geographic region 100 after it has been divided into a first plurality of media consumption markets, such as a first plurality of markets 102a-g. The geographic identifiers that share the same affiliate stations for all of a plurality of national television networks, such as NBC, FOX, ABC, and CBS, may be grouped together to form the first plurality of media consumption markets. For example, in FIG. 1A, each geographic identifier grouped into the market 102a may share the same affiliate stations for all of the plurality of national television networks. Similarly, each geographic identifier grouped into the market 102b may share the same affiliate stations for all of the plurality of national television networks. However, the geographic identifiers grouped into the market 102a do not share all of the same affiliate stations with the geographic identifiers grouped into any of the markets 102b-g. For example, the geographic identifiers grouped into the market 102a may share only some or none of the same affiliate stations with the geographic identifiers grouped into any of the markets 102b-g.

Grouping the geographic region 100 into the first plurality of media consumption markets may result in the identification of a large number of markets. While the geographic region 100 of FIG. 1A has only been grouped into seven different markets, the quantity of markets may be larger for different geographic regions. For example, if a different geographic region, such as the United States, is grouped into the first plurality of media consumption markets, over 300 markets may be identified. It may not be optimal to have such a large number of media consumption markets. For example, a business entity may be seeking to identify media consumption markets in order to provide marketing data and analytics to enterprises, media and advertising agencies, or publishers. If over 300 markets have been identified, then it may be difficult for the business entity to provide such marketing data and analytics. As a result, it may be desirable to merge some of the markets in the first plurality of media consumption markets together to create a smaller number of media consumption markets.

FIG. 1B illustrates the geographic region 100 after some of the markets in the first plurality of media consumption markets, such as the markets 102a-g of FIG. 1A, have been merged together. Merging some of the markets in the first plurality of media consumption markets together may generate a second plurality of media consumption markets, such as a second plurality of markets 106a-c. For example, markets 102a and 102b of FIG. 1A may be merged together to create the market 106a of FIG. 1B. Similarly, the markets 102c and 102d of FIG. 1A may be merged together to create the market 106b of FIG. 1B and the markets 102e-g of FIG. 1A may be merged together to create the market 106c of FIG. 1B.

Merging the markets from the first plurality of media consumption markets together to generate the second plurality of media consumption markets may be accomplished by determining which markets from the first plurality of media consumption markets share an affiliate station for a first subset of the plurality of national television networks, such as three of the national television networks. Two or more markets from the first plurality of media consumption markets may be merged together if they share an affiliate station for the first subset of the plurality of national television network. For example, two or more markets from the first plurality of media consumption markets, such as the markets 102c and 102d of FIG. 1A, may be merged together if they share a FOX, NBC, and CBS affiliate but do not share an ABC affiliate. As another example, two or more markets from the first plurality of media consumption markets, such as the markets 102e-g of FIG. 1A, may be merged together if they share a CBS, NBC, and ABC affiliate but do not share a FOX affiliate.

As the second plurality of media consumption markets is the product of merging markets from the first plurality of media consumption markets together, the second plurality of media consumption markets contains fewer markets than the first plurality of media consumption markets did. This smaller number of markets may be desirable to a business entity, such as the business entity described above. However, it may be desirable to even further reduce the number of media consumption markets. To do so, some of the markets from the second plurality of media consumption markets may be merged together to generate an ever smaller, third plurality of media consumption markets.

FIG. 1C illustrates the geographic region 100 after some of the markets in the second plurality of media consumption markets, such as the markets 106a-c of FIG. 1B, have been merged together. Merging some of the markets in the second plurality of media consumption markets together may generate a third plurality of media consumption markets, such as a third plurality of markets 108a-b. For example, markets 106b and 106c of FIG. 1B may be merged together to create the market 108b of FIG. 1C.

Merging the markets from the second plurality of media consumption markets together to generate the third plurality of media consumption markets may be accomplished by determining which markets from the second plurality of media consumption markets share an affiliate station for a second subset of the plurality of national television networks. The second subset is smaller than the first subset described above. For example, if the first subset was defined as three of the national television networks, the second subset may be defined as two of the national television networks. Two or more markets from the second plurality of media consumption markets may be merged together if they share an affiliate station for the second subset of the plurality of national television network. For example, two or more markets from the second plurality of media consumption markets, such as the markets 106b and 162c of FIG. 1B, may be merged together if they share an NBC and CBS affiliate but do not share a FOX or ABC affiliate.

As the third plurality of media consumption markets is the product of merging markets from the second plurality of media consumption markets together, the third plurality of media consumption markets contains fewer markets than the second plurality of media consumption markets did. This smaller number of markets may be desirable to a business entity, such as the business entity described above. However, even after the number of markets has been reduced, a particular county may still be split between more than one market. For example, each of FIG. 1A-C illustrates “County A” being split between more than one market. It may be desirable for a single county to belong to a single market. To accomplish this, some of the geographic identifiers associated with the split county may be reassigned from one market to another market. For example, as illustrated in FIG. 1D, the geographic identifiers belonging to “County A” that have been assigned to market 108b may be reassigned to market 108a. In another example, the geographic identifiers belonging to “County A” that have been assigned to market 108a may be reassigned to market 108b. After reassignment, the geographic identifiers belonging to the split county may all be assigned to the market containing a greater number of the split county's households, based on available population data.

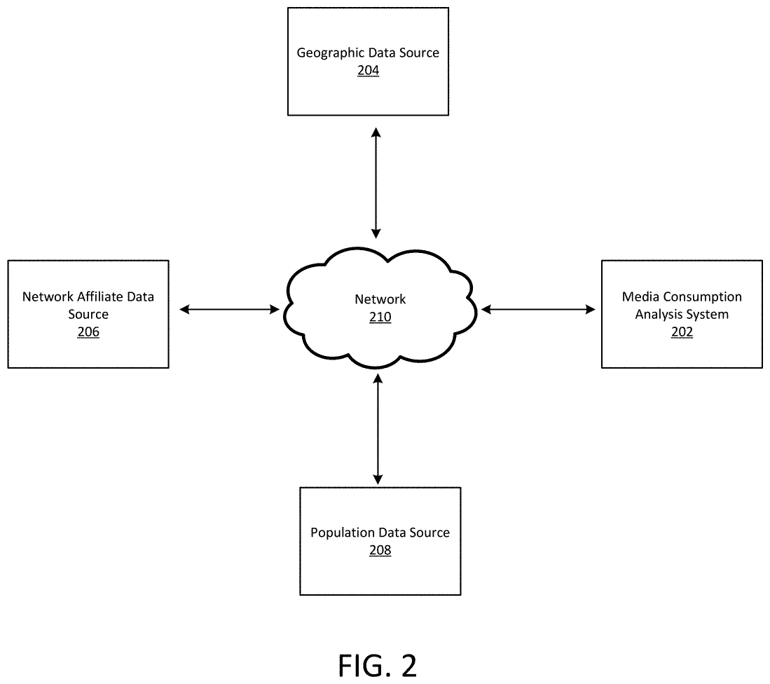

While it may be desirable for the geographic identifiers belonging to the split county to all be assigned to one market, such as the market containing the greater number of households, it may not always be possible to assign all of the geographic identifiers belonging to the split county to a single market. It may not be possible to do so if the boundaries of the geographic identifiers do not line up with county boundaries. In this case, most of the geographic identifiers belonging to the split county may be assigned to one market, such as the market containing the greater number of households, while some of the geographic identifiers belonging to the split county may still be assigned to a different market. FIG. 2 illustrates an example hardware and network configuration in which the systems and methods described herein may be implemented. Such a hardware and network configuration includes a media consumption analysis system 202, a geographic data source 204, a network affiliate data source 206, and a population data source 208. The media consumption analysis system 202, the geographic data source 204, the network affiliate data source 206, and the population data source 208 are in communication via a network 210. The media consumption analysis system 202 may be associated with a business entity seeking to identify media consumption markets, such as the business entity described above.

The media consumption analysis system 202 may implement a number of the functions and techniques described herein. For example, the media consumption analysis system 202 may receive, from the geographic data source 204, geographic data indicating various geographic areas within a region. The geographic data may indicate a geographic identifier associated with each area. For example, the geographic data may indicate ZIP codes, area codes, latitude-longitude values, city names, neighborhood names, county names, or census designated places within a region, such as the region 100 associated with FIGS. 1A-D.

The media consumption analysis system 202 may also receive, from the network affiliate data source 206, television network affiliate data indicating the various affiliate stations available in different geographic areas and the communication mediums associated with the various affiliate stations. The media consumption analysis system 202 may also receive, from the network affiliate data source 206, fine-grained location-level data indicating the available transmission sources of television programming and advertising and the associated data providers and communication mediums. For example, the fine-grained location-level data may indicate, for each geographic area, the satellite and cable television service companies offering the television programming to paid subscribers. The fine-grained location-level data may also indicate, for each geographic area, the presence of over-the-air (OTA) broadcasting of media programming. The media consumption analysis system 202 may also receive, from the population data source 208, population data indicating the current and/or historical populations or number of households associated with different geographic areas. For example, the population data may indicate the current and/or historical populations or number of households associated with various markets to which one or more geographic identifiers have been assigned.

The media consumption analysis system 202 may input the television network data and the fine-grained location level data to a model to determine, for different geographic areas, a primary local affiliate station for various national television networks. For example, the media consumption analysis system 202 may determine which affiliate station for a particular national television network is carried by a majority of headends associated with different geographic areas. A headend may be equipment or a facility that receives communications signals, such as cable television broadcasts, for distribution to a geographic area. The affiliate station that is carried by the majority of headends in a geographic area is the geographic area's primary local affiliate station for that national television network. A geographic area may have a primary local affiliate station for all, some, or none of a plurality of national television networks, such as FOX, CBS, NBC, and ABC.

The media consumption analysis system 202 may input the geographic data to identify media consumption boundaries. The media consumption analysis system 202 may use the geographic data and the primary local affiliate station data to predict the media consumption boundaries. Such media consumption boundaries may define a plurality of media consumption markets, such as the first, second, or third plurality of markets described above in reference to FIGS. 1A-D. In an embodiment, the media consumption analysis system 202 may merge markets together in order to generate a smaller set of markets. For example, the media consumption analysis system may merge together the markets 106b and 106c of FIG. 1B to create the market 108b of FIG. 1C. The media consumption analysis system 202 may assign geographic areas to the media consumption markets defined by the boundaries. For example, the media consumption analysis system 202 may assign various ZIP codes to different media consumption markets. The media consumption analysis system 202 may assign the geographic areas to the media consumption markets based at least in part on the primary local affiliate data.

The media consumption analysis system 202 may generate and output one or more reports indicating the media consumption boundaries and the markets defined by the media consumption boundaries. The report may indicate local media consumption patterns across different geographic areas.

As noted, the geographic data source 204, the network affiliate data source 206, and the population data source 208 may respectively provide the geographic data, the television network data and the fine-grained location level data, and the population data to the media consumption analysis system 202. In some embodiments, one or more of the geographic data source 204, the network affiliate data source 206, or the population data source 208 may be integrated with the media consumption analysis system 202. One or more of the geographic data source 204, the network affiliate data source 206, and the population data source 208 may be associated with a government entity. For example, population data may be provided by the relevant census bureau.

The media consumption analysis system 202 and the geographic data source 204, the network affiliate data source 206, and the population data source 208 may each comprise one or more computing devices and/or network devices. For example, the media consumption analysis system 202 and the geographic data source 204 may each comprise one or more networked servers. The media consumption analysis system 202 and the geographic data source 204, the network affiliate data source 206, and the population data source 208 may each comprise a data storage device and/or system, such as a network-attached storage (NAS) system.

The network 210 may comprise one or more public networks (e.g., the Internet) and/or one or more private networks. A private network may include a wireless local area network (WLAN), a local area network (LAN), a wide area network (WAN), a cellular network, or an intranet. The network 210 may comprise wired network(s) and/or wireless network(s).

As noted, the geographic data source 204, the network affiliate data source 206, the population data source 208, and the media consumption analysis system 202 may each be implemented in one or more computing devices. Such a computing device may comprise one or more processors and memory storing instructions that, when executed by the one or more processors, cause the computing device to perform one or more of the various methods or techniques described here. The memory may comprise volatile memory (e.g., random access memory (RAM)) and/or non-volatile memory (e.g., a hard or solid-state drive). The memory may comprise a non-transitory computer-readable medium. The computing device may comprise one or more input devices, such as a mouse, a keyboard, or a touch interface. The computing device may comprise one or more output devices, such as a monitor or other video display. The computing device may comprise an audio input and/or output. The computing device may comprise one or more network communication interfaces, such as a wireless transceiver (e.g., Wi-Fi or cellular) or wired network interface (e.g., ethernet). The one or more network communication interfaces may be configured to connect to the network 210.

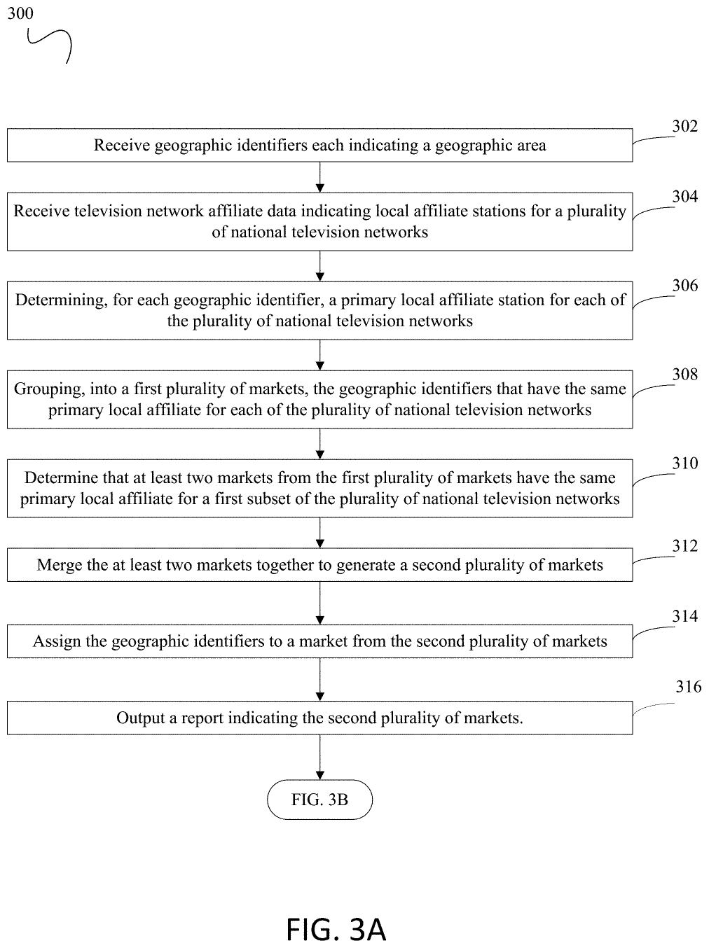

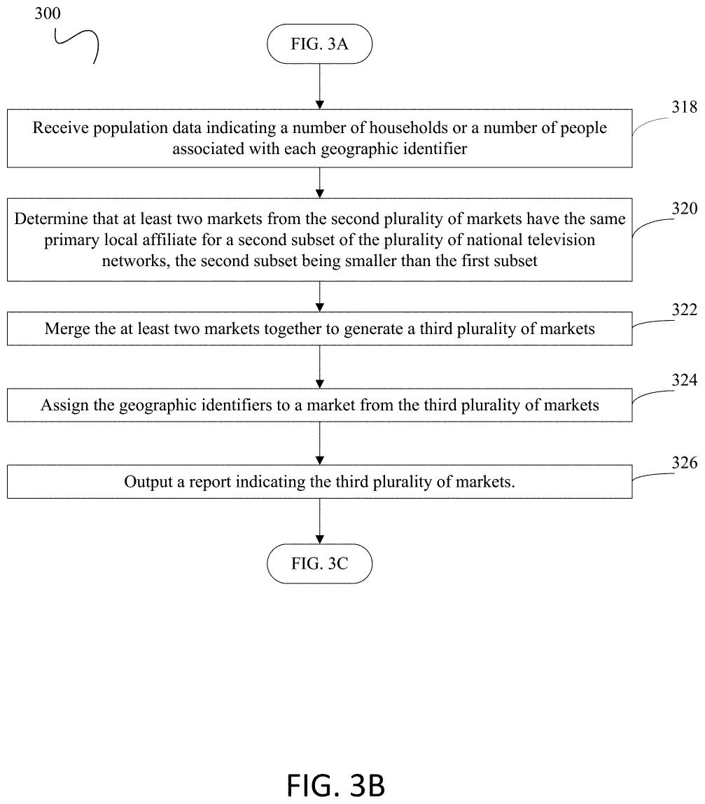

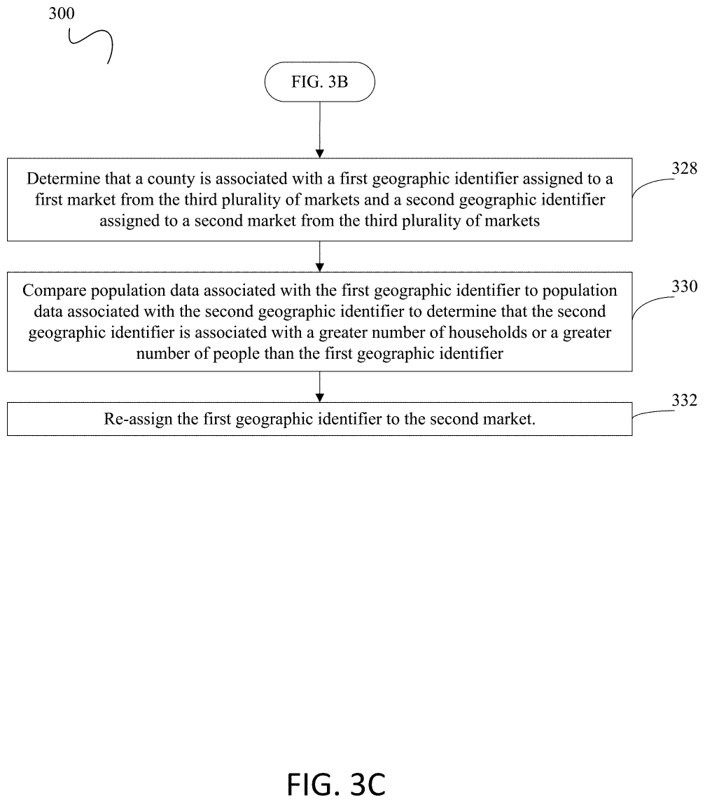

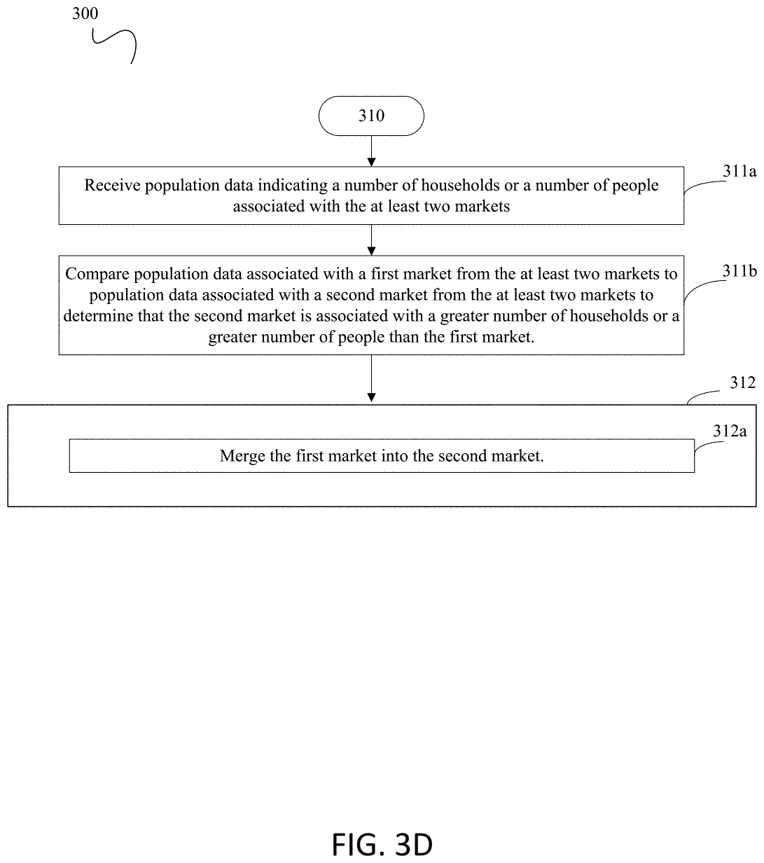

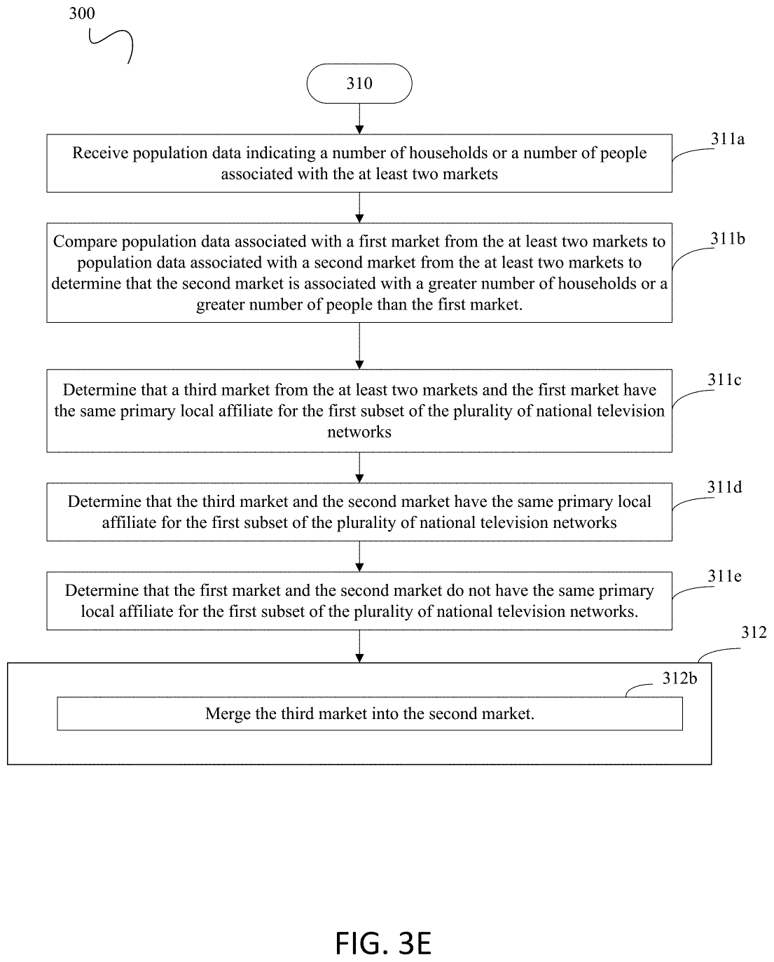

FIGS. 3A-E illustrates an exemplary method 300 for defining media consumption markets, such as the markets 102a-g, 106a-c, 108a-b associated with FIGS. 1A-D. The method 300 may be performed, for example, by the media consumption analysis system 202 of FIG. 2. Geographic areas, which may each be indicated by a geographic identifier such as a ZIP code, that share a primary local affiliate for each of a plurality of national television networks may be grouped into a first plurality of markets. The plurality of national television networks may include a predetermined number of national television networks. In an embodiment, the plurality of national television networks may include four of the largest national television networks, such as FOX, NBC, CBS, and ABC. If the plurality of national television networks includes four national television networks, geographic areas that share a primary local affiliate for all four of the national television networks may be grouped into the first plurality of markets.

Each geographic area may not share a primary local affiliate for each of the plurality of national television networks with a large number of other geographic areas. As a result, the quantity of markets in the first plurality of markets may be large. Because the first plurality of markets may include a large quantity of markets, it may be desirable to merge some of the markets in the first plurality of markets together to generate a smaller, second plurality of markets. The markets in the first plurality of markets may be merged together if they have a partially matching set of local affiliates for the plurality of national television networks. The partially matching set of local affiliates may include a first predetermined subset of the national television networks. For example, if the plurality of national television networks includes four national television networks, the first predetermined subset may include three of the four national television networks. Geographic areas that share a primary local affiliate for three of the four national television networks may be merged together to generate the second plurality of markets.

Once the second plurality of markets is created, it may be desirable to further reduce the number of markets. Again, markets from the second plurality of markets may be merged together to generate an even smaller, third plurality of markets. Two or more markets in the second plurality of markets may be merged together if they have a partially matching set of local affiliates for the plurality of national television networks. The partially matching set of local affiliates may include a second predetermined subset of the national television networks, the second predetermined subset being smaller than the first predetermined subset. For example, if the plurality of national television networks includes four national television networks and the first predetermined subset includes three of the four national television networks, the second predetermined subset may include two of the four national television networks. Geographic areas that share a primary local affiliate for two of the four national television networks may be merged together to generate the third plurality of markets.

It may be desirable for a single county to belong to a single market. If a county is split between two different markets, part of the county may need to be reassigned to a different market to ensure that the entire county belongs to one market. However, as discussed above, while it may be desirable for a single county to belong to one market, it may not always be possible to assign all of the geographic identifiers belonging to a split county to a single market. It may not be possible to do so if the boundaries of the geographic identifiers do not line up with the county boundaries. In this case, most of the geographic identifiers belonging to the split county may be assigned to one market while some of the geographic identifiers belonging to the split county may still be assigned to a different market.

At step 302, geographic identifiers, each indicating a geographic area may be received. The geographic identifiers may be received, for example, from a data source such as the geographic data source 204 of FIG. 2. The geographic identifiers may each be associated with a geographic boundary that defines the geographic area. The geographic identifiers may include at least one of ZIP codes, area codes, latitude-longitude values, city names, neighborhood names, county names, or census designated places. For example, the geographic identifiers may be ZIP codes that define geographic areas having different postal codes within a region, such as the region 100 of FIG. 1. As another example, the geographic identifiers may be city names that define the city boundaries within a region, such as the region 100 of FIG. 1.

At step 304, television network affiliate data indicating local affiliate stations for a plurality of national television networks may be received. The television network affiliate data may be received, for example, from a data source such as the network affiliate data source 206 of FIG. 2. As described above with respect to FIG. 2, the television network affiliate data may indicate the various affiliate stations available in different geographic areas and the communication mediums associated with the affiliate stations. The television network affiliate data may also include fine-grained location-level data indicating the available transmission sources of television programming and advertising and the associated data providers and communication mediums.

The television network affiliate data may indicate multiple affiliate stations for a single national television network in a geographic area. In some embodiments, these multiple affiliate stations should be grouped together and treated as one affiliate station. For example, multiple affiliate stations should be grouped together and treated as one affiliate station if the multiple affiliate stations show the same or mostly the same content. In an embodiment, the television network affiliate data may indicate a high definition (HD) affiliate station and a standard definition (SD) affiliate station for a single national television network in a geographic area. The HD affiliate station and the SD affiliate station may be grouped together and treated as one affiliate station for the national television network.

In another embodiment, the television network affiliate data may indicate a full satellite station that airs the same content, including local news, as another affiliate station for a national television network in a geographic area. The full satellite station and the other affiliate station may be grouped together and treated as one affiliate station for the national television network because they air the same content. In another embodiment, the television network affiliate data may indicate a semi-satellite station that airs mostly the same content as another affiliate station for a national television network in a geographic area. Although the semi-satellite station airs content that has small variations from the content aired by the other affiliate station, the semi-satellite station and the other affiliate station may still be grouped together and treated as one affiliate station for the national television network.

At step 306, a primary local affiliate station for each of the plurality of national television networks may be determined for each geographic identifier. This determination may be made, for example, by the media consumption analysis system 202 of FIG. 2. As discussed above, the primary local affiliate station for a national television network in a geographic area may be the affiliate station that is carried by a majority of headends in the geographic area. The headends associated with each geographic identifier comprise at least one of an OTA headend, a cable television headend, or a DBS headend. A geographic area may have a primary local affiliate station for all, some, or none of a plurality of national television networks, such as FOX, CBS, NBC, and ABC.

To determine the primary local affiliate station for a particular network from the plurality of national television networks in a geographic area, the media consumption analysis system 202 may determine whether there is a single OTA affiliate station available for the network in the geographic area. For example, the media consumption analysis system 202 may determine whether there is a single OTA affiliate FOX station available in the geographic area. If there is a single OTA affiliate station available for the network in the geographic area, the media consumption analysis system 202 may determine that the single OTA affiliate station is the primary local affiliate station for the network in the geographic area. If there are multiple OTA affiliate stations for the network in the geographic area, that network may not have a primary local OTA affiliate in the geographic area.

If there are no OTA affiliate stations or multiple OTA affiliate stations available for the network in the geographic area, the media consumption analysis system 202 may determine whether there is a single cable affiliate station available for the network in the geographic area. If there is a single cable affiliate station available for the network in the geographic area, the media consumption analysis system 202 may determine that the single cable affiliate station is the primary local affiliate for the network in the geographic area. If there are multiple cable affiliate stations available for the network in the geographic area, the network may not have a primary local cable affiliate in the geographic area.

If there are no cable affiliate stations or multiple cable affiliate stations available for the network in the geographic area, the media consumption analysis system may determine whether there is a single direct broadcast satellite (DBS) affiliate station available for the network in the geographic area. If there is a single DBS affiliate station available for the network in the geographic area, the media consumption analysis system 202 may determine that the single DBS affiliate station is the primary local affiliate for the network in the geographic area. If there are multiple DBS affiliate stations available for the network in the geographic area, the network may not have a primary local DBS affiliate in the geographic area.

A network that does not have a primary local OTA affiliate, a primary local cable affiliate, or a primary local DBS affiliate may not have a primary local affiliate in the geographic area. While the geographic area may have access to television programming provided by the network via one or more out-of-market (OOM) stations, the media consumption analysis system 202 will exclude these OOM stations from its analysis. Such OOM stations may, for example, be accessed by a consumer in the geographic region via Layer3, PlayStation, YouTube, Fubotv, Hulu, Sling, or DIRECTV. For example, DIRECTV may provide a geographic area associated with a California ZIP code with access to an OOM New York station. If a network does not have a primary local affiliate in the geographic region, the primary local affiliate for the network in the geographic area may be assigned a value of zero.

The media consumption analysis system 202 may repeat the above process for each of the networks from the plurality of national television network in a plurality of geographic areas. After it has done so, the media consumption analysis system 202 may output the primary local affiliate station for each network from the plurality of national television networks in the plurality of geographic areas. For example, the media consumption analysis system 202 may output the primary FOX affiliate station, the primary ABC affiliate station, the primary NBC affiliate station, and the primary CBS affiliate station for each ZIP code in a geographic region.

At step 308, the geographic identifiers that have the same primary local affiliate for each of the plurality of national television networks may be grouped together into a first plurality of markets, such as the first plurality of markets 102a-g of FIG. 1. If the plurality of national television works includes four national television networks, such as FOX, CBS, NBC, and ABC, the geographic identifiers that have the same primary local FOX affiliate, CBS affiliate, NBC affiliate, and ABC affiliate may be grouped together into the first plurality of markets. If a geographic identifier has a primary local affiliate with a value of zero for one or more of the national television networks, then this geographic identifier may not be grouped into any of the markets in the first plurality of markets. Geographic identifiers that are not grouped into any of the markets in the first plurality of markets may be assigned to a market at a later time, as discussed below.

As discussed above, the first plurality of markets may include a large number of markets and it may be desirable to reduce the number of markets. Markets in the first plurality of markets may be merged together to create a second, smaller plurality of markets. For example, at step 310, it may be determined that at least two markets from the first plurality of markets have the same primary local affiliate for a first subset of the plurality of national television networks. The first subset may include a predetermined subset of national television networks from the plurality of national television networks. For example, if the plurality of national television works includes four national television networks, the first subset may include three of the four national television networks. If two markets from the first plurality of markets have the same primary local affiliate for three of the four national television networks, the two markets may be merged together.

Merging two markets from the first plurality of markets together may comprise merging the smaller of the two markets into the larger of the two markets. As shown in FIG. 3D, population data may be used to determine which of the two markets is the larger market and which of the two markets is the smaller market. Other types of data may also be used instead of or in addition to population data. For example, data indicating the square mileage of the two markets, the size of the markets according to a particular demographic group, or television and media consumption within the markets may be used. At step 311a, the data used to determine which of the two markets is the larger market, such as population data, may be received. For example, the data may be received from a data source, such as the population data source 208. The data may indicate a number of households or a number of people associated with the two markets. In an embodiment, the data may indicate a number of households owning a television. The larger of the two markets may be the market associated with the greater number of households or the greatest number of people, or both.

At step 311b, the data associated with the two markets may be compared to determine which market is the larger market. It may be determined that a first market from the two markets is larger than a second market from the two markets. For example, it may be determined that the second market is associated with a greater number of households than the first market, a greater number of people than the first market, or both. In an embodiment, it may be determined that the second market is associated with a greater number of households owning a television than the first market. If the second market is larger than the first market, the first market may be merged into the second market, such as at step 312, to create the second plurality of markets.

In an embodiment, a smaller market may have the same primary local affiliate for the first subset of national television networks as two more larger markets. As shown in FIG. 3E, the smaller market may be merged into the largest of the two or more larger markets. At step 311c, it may be determined that a smaller market, such as a third market, has the same primary local affiliate for the first subset of national television networks as a larger market, such as a first market. At step 311d, it may be determined that the third market third market and a second market also have the same primary local affiliate for the first subset of the national television networks. In other words, the third market has the same primary local affiliate for the first subset of national television networks as both the first and second markets. At step 311e, it may be determined that the first market and the second market do not have the same primary local affiliate for the first subset of national television networks. Because the first and second markets do not share the same primary local affiliate for the first subset of national television networks, they cannot be merged together. Accordingly, the third market can only be merged into one of the first market or the second market.

The third market will be merged into the market that is larger according to population data. For example, it may be determined that the second market is associated with a greater number of households than the first market, a greater number of people than the first market, or both. In an embodiment, it may be determined that the second market is associated with a greater number of households owning a television than the first market. If the second market is larger than the first market, the third market may be merged into the second market, such as at step 312, to create the second plurality of markets.

At step 312, the markets may be merged together to generate a second plurality of markets. As discussed above, smaller markets will be merged into larger markets. Additionally, a smaller market that has the same primary local affiliate for the first subset of national television networks as two more larger markets will be merged into the largest of the two or more larger markets.

At step 314, each of the geographic identifiers may be assigned to a market from the second plurality of markets. Each market from the second plurality of markets may be associated with a primary local affiliate for each of the plurality of national television networks. A geographic identifier may be assigned to the market having the most primary local affiliates in common. For example, if a geographic identifier has all primary local affiliates in common with a market, the geographic identifier will be assigned to that market. If a geographic identifier does not have all primary local affiliates in common with any market, then the geographic identifier may be assigned to the market with the most affiliate stations in common. This may cause a geographic identifier to be assigned to multiple markets. However, it may be desirable for a geographic identifier to be assigned only to one market. If a geographic identifier is assigned to multiple markets, the geographic identifier may be reassigned to the largest of the multiple markets based on data, such as population data, data indicating the square mileage of the two markets, data indicating the size of the markets according to a particular demographic group, or data indicating television and media consumption within the markets

At step 316, a report indicating the second plurality of markers may be output. The report may be generated by, for example, the media consumption analysis system 202 of FIG. 2. The report may indicate which geographic identifiers belong to which markets from the second plurality of markets. The report may also indicate the primary local affiliates associated with each market from the second plurality of markets, as well as the primary local affiliates associated with each geographic identifier assigned to each market.

As discussed above, the second plurality of markets may still include a large number of markets and it may be desirable to further reduce the number of markets. Markets in the second plurality of markets may be merged together to create a third, even smaller plurality of markets. For example, at step 320, it may be determined that at least two markets from the second plurality of markets have the same primary local affiliate for a second subset of the plurality of national television networks. The second subset may include a smaller, predetermined subset of national television networks from the plurality of national television networks than the first subset. For example, if the plurality of national television works includes four national television networks, and the first subset includes three of the four national television networks, the second subset may include two of the four national television networks. If two markets from the second plurality of markets have the same primary local affiliate for two of the four national television networks, the two markets may be merged together.

The two markets from the second plurality may be merged together based at least in part on population data. For example, at step 318, population data associated with each geographic identifier may be received. The population data may be received, for example, from a data source such as the population data source 208. The population data may indicate a number of households or a number of people associated with the two markets. In an embodiment, the population data may indicate a number of households owning a television. The larger of the two markets may be the market associated with the greater number of households or the greatest number of people, or both. The smaller market may be merged into the larger market.

However, the smaller market may only be merged into the larger market if the smaller market satisfies either a population threshold or a geographic identifier threshold. If the smaller market has been assigned multiple geographic identifiers, such as multiple ZIP codes, the smaller market must satisfy the population threshold. The smaller market may satisfy the population threshold if the combined population data for the multiple geographic identifiers is below a predetermined threshold. For example, the smaller market may satisfy the population threshold if the geographic identifiers are associated with a combined number of households or a combined number of people below a predetermined threshold. In an embodiment, the smaller market may satisfy the population threshold if the geographic identifiers, when combined, are associated with less than 20,000 households. If the smaller market has been assigned only a single geographic identifier threshold, such as one ZIP code, the smaller market may satisfy the geographic identifier threshold. If it is determined that the smaller market satisfies either the population or geographic identifier threshold, the smaller market may be merged into the larger market, at step 322, to generate the third plurality of markets.

At step 324, the geographic identifiers may be assigned to a market from the third plurality of markets. Each market from the third plurality of markets may be associated with a primary local affiliate for each of the plurality of national television networks. A geographic identifier may be assigned to the market having the most primary local affiliates in common. For example, if a geographic identifier has all primary local affiliates in common with a market, the geographic identifier will be assigned to that market. If a geographic identifier does not have all primary local affiliates in common with any market, then the geographic identifier may be assigned to the market with the most affiliate stations in common. This may cause a geographic identifier to be assigned to multiple markets. However, it may be desirable for a geographic identifier to be assigned only to one market. If a geographic identifier is assigned to multiple markets, the geographic identifier will be reassigned only to the largest of the multiple markets based on population data.

At step 326, a report indicating the third plurality of markets may be output. The report may be generated by, for example, the media consumption analysis system 202 of FIG. 2. The report may indicate which geographic identifiers belong to which markets from the third plurality of markets. The report may also indicate the primary local affiliates associated with each market from the third plurality of markets, as well as the primary local affiliates associated with each geographic identifier assigned to each market.

As discussed above, it may be desirable for a single county to belong to a single market. However, a single county may be associated with more than one geographic identifier, and those different geographic identifiers may be assigned to different markets. For example, a single county may contain more than one ZIP code. As a result, a county, such as “County A” of FIGS. 1A-C, may be split between different markets. At step 328, it may be determined that a county is associated with a first geographic identifier assigned to a first market from the third plurality of markets and a second geographic identifier assigned to a second market from the third plurality of markets. For example, it may be determined that a county is associated with a first ZIP code that is assigned to a first market and is also associated with a second ZIP code that is assigned to a second, different market.

At step 330, population data associated with the first geographic identifier may be compared to population data associated with the second geographic identifier to determine that the second geographic identifier is associated with a greater number of households or a greater number of people than the first geographic identifier. At step 332, the first geographic identifier may be reassigned to the second market. For example, a ZIP code from the market with fewer county households may be reassigned to the market with more of the county's households. In an embodiment, the ZIP code from the market with fewer county households owning a television may be reassigned to the market with more of the county's households owning a television. In another example, a ZIP code from the market with less of the county's population may be reassigned to the market with more of the county's population.

After this reassignment, the county may belong to a single market. However, as discussed above, while it may be desirable for the county to belong to one market, such as the market containing the greater number of households, it may not always be possible to assign all of the geographic identifiers belonging to the split county to a single market. It may not be possible to do so if the boundaries of the geographic identifiers do not line up with county boundaries. In this case, most of the geographic identifiers belonging to the split county may be assigned to one market, such as the market containing the greater number of households, while some of the geographic identifiers belonging to the split county may still be assigned to a different market.

As discussed above at step 308, one or more geographic identifiers may have a primary local affiliate with a value of zero for one or more of the national television networks. As a result, these geographic identifiers may not have been grouped into any of the markets in the preceding steps of method 300. To assign these geographic identifiers to a market, the existing primary local affiliates for these geographic identifiers may be compared with the primary local affiliates associated with each of the markets, such as the markets in the second or third plurality of markets. These geographic identifiers may be assigned to the market that has the most primary local affiliates in common. Some geographic identifiers may not have any primary local affiliates. Such geographic identifiers may be assigned to the same market as the rest of the geographic identifiers belonging to the same county.

As described above, a geographic identifier may be reassigned to a market that it was not originally assigned to. In some cases, such a reassignment may cause a geographic identifier to be assigned to one market when the other market was actually a better geographical fit. For example, Palm Springs is a smaller market next to Los Angeles. A geographic identifier near major cities in Palm Springs may be assigned to the larger Los Angeles market. This may be, at least in part, due to the geographic identifier having multiple OTA affiliates available. However, some of the geographic identifiers near major cities in Palm Springs, such as those in the eastern portion of Riverside County, could not actually view Los Angeles stations via OTA. The geographic identifiers in the eastern portion of Riverside County could not view Los Angeles stations via OTA due to the large size of the Riverside County and due to mountains blocking the Los Angeles stations' OTA signals from reaching the eastern portion of Riverside County. Similarly, geographic identifiers near major cities on the very eastern edge of Palm Springs may not be able to view Palm Springs stations via OTA either. To address this issue, OTA headends for the respective stations were removed from consideration.

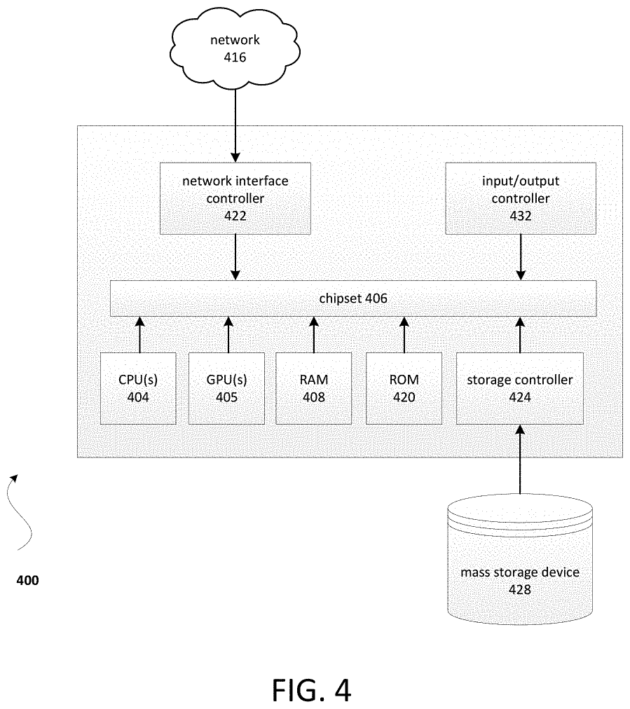

FIG. 4 depicts a computing device that may be used in various aspects. With regard to the example environment of FIG. 2, one or more of the media consumption analysis system 202, the geographic data source 204, the network affiliate data source 206, or the population data source 208 may be implemented in an instance of a computing device 400 of FIG. 4. The computer architecture shown in FIG. 4 shows a conventional server computer, workstation, desktop computer, laptop, tablet, network appliance, PDA, e-reader, digital cellular phone, or other computing node, and may be utilized to execute any aspects of the computers described herein, such as to implement the methods described in FIGS. 3A-E.

The computing device 400 may include a baseboard, or “motherboard,” which is a printed circuit board to which a multitude of components or devices may be connected by way of a system bus or other electrical communication paths. One or more central processing units (CPUs) 404 may operate in conjunction with a chipset 406. The CPU(s) 404 may be standard programmable processors that perform arithmetic and logical operations necessary for the operation of the computing device 400.

The CPU(s) 404 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 404 may be augmented with or replaced by other processing units, such as GPU(s) 405. The GPU(s) 405 may comprise processing units specialized for but not necessarily limited to highly parallel computations, such as graphics and other visualization-related processing.

A user interface may be provided between the CPU(s) 404 and the remainder of the components and devices on the baseboard. The interface may be used to access a random access memory (RAM) 408 used as the main memory in the computing device 400. The interface may be used to access a computer-readable storage medium, such as a read-only memory (ROM) 420 or non-volatile RAM (NVRAM) (not shown), for storing basic routines that may help to start up the computing device 400 and to transfer information between the various components and devices. ROM 420 or NVRAM may also store other software components necessary for the operation of the computing device 400 in accordance with the aspects described herein. The user interface may be provided by a one or more electrical components such as the chipset 406.

The computing device 400 may operate in a networked environment using logical connections to remote computing nodes and computer systems through local area network (LAN) 416. The chipset 406 may include functionality for providing network connectivity through a network interface controller (NIC) 422, such as a gigabit Ethernet adapter. A NIC 422 may be capable of connecting the computing device 400 to other computing nodes over a network 416. It should be appreciated that multiple NICs 422 may be present in the computing device 400, connecting the computing device to other types of networks and remote computer systems.

The computing device 400 may be connected to a storage device 428 that provides non-volatile storage for the computer. The storage device 428 may store system programs, application programs, other program modules, and data, which have been described in greater detail herein. The storage device 428 may be connected to the computing device 400 through a storage controller 424 connected to the chipset 406. The storage device 428 may consist of one or more physical storage units. A storage controller 424 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 400 may store data on a storage device 428 by transforming the physical state of the physical storage units to reflect the information being stored. The specific transformation of a physical state may depend on various factors and on different implementations of this description. Examples of such factors may include, but are not limited to, the technology used to implement the physical storage units and whether the storage device 428 is characterized as primary or secondary storage and the like.

For example, the computing device 400 may store information to the storage device 428 by issuing instructions through a storage controller 424 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 400 may read information from the storage device 428 by detecting the physical states or characteristics of one or more particular locations within the physical storage units.

In addition or alternatively to the storage device 428 described herein, the computing device 400 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 400.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A storage device, such as the storage device 428 depicted in FIG. 4, may store an operating system utilized to control the operation of the computing device 400. The operating system may comprise a version of the LINUX operating system. The operating system may comprise a version of the WINDOWS SERVER operating system from the MICROSOFT Corporation. According to additional aspects, the operating system may comprise a version of the UNIX operating system. Various mobile phone operating systems, such as IOS and ANDROID, may also be utilized. It should be appreciated that other operating systems may also be utilized. The storage device 428 may store other system or application programs and data utilized by the computing device 400.

The storage device 428 or other computer-readable storage media may also be encoded with computer-executable instructions, which, when loaded into the computing device 400, transforms the computing device from a general-purpose computing system into a special-purpose computer capable of implementing the aspects described herein. These computer-executable instructions transform the computing device 400 by specifying how the CPU(s) 404 transition between states, as described herein. The computing device 400 may have access to computer-readable storage media storing computer-executable instructions, which, when executed by the computing device 400, may perform the methods described in relation to FIGS. 2-3.

A computing device, such as the computing device 400 depicted in FIG. 4, may also include an input/output controller 432 for receiving and processing input from a number of input devices, such as a keyboard, a mouse, a touchpad, a touch screen, an electronic stylus, or other type of input device. Similarly, an input/output controller 432 may provide output to a display, such as a computer monitor, a flat-panel display, a digital projector, a printer, a plotter, or other type of output device. It will be appreciated that the computing device 400 may not include all of the components shown in FIG. 4, may include other components that are not explicitly shown in FIG. 4, or may utilize an architecture completely different than that shown in FIG. 4.

As described herein, a computing device may be a physical computing device, such as the computing device 400 of FIG. 4. A computing node may also include a virtual machine host process and one or more virtual machine instances. Computer-executable instructions may be executed by the physical hardware of a computing device indirectly through interpretation and/or execution of instructions stored and executed in the context of a virtual machine.

One skilled in the art will appreciate that the systems and methods disclosed herein may be implemented via a computing device that may comprise, but are not limited to, one or more processors, a system memory, and a system bus that couples various system components including the processor to the system memory. In the case of multiple processors, the system may utilize parallel computing.

For purposes of illustration, application programs and other executable program components such as the operating system are illustrated herein as discrete blocks, although it is recognized that such programs and components reside at various times in different storage components of the computing device, and are executed by the data processor(s) of the computer. An implementation of service software may be stored on or transmitted across some form of computer-readable media. Any of the disclosed methods may be performed by computer-readable instructions embodied on computer-readable media. Computer-readable media may be any available media that may be accessed by a computer. By way of example and not meant to be limiting, computer-readable media may comprise “computer storage media” and “communications media.” “Computer storage media” comprise volatile and non-volatile, removable and non-removable media implemented in any methods or technology for storage of information such as computer-readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer. Application programs and the like and/or storage media may be implemented, at least in part, at a remote system.

As used in the specification and the appended claims, the singular forms “a,” “an” and “the” include plural referents unless the context clearly dictates otherwise. Ranges may be expressed herein as from “about” one particular value, and/or to “about” another particular value. Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect.

It will be apparent to those skilled in the art that various modifications and variations may be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method comprising:
receiving geographic identifiers each indicating a geographic area;
receiving television network affiliate data indicating local affiliate stations for a plurality of national television networks;
determining, for each geographic identifier, a primary local affiliate station for each of the plurality of national television networks;
grouping, into a first plurality of markets, the geographic identifiers that have the same primary local affiliate for each of the plurality of national television networks;
determining that at least two markets from the first plurality of markets have the same primary local affiliate for a first subset of the plurality of national television networks;
merging the at least two markets together to generate a second plurality of markets;
assigning each geographic identifier to a market from the second plurality of markets; and
outputting a report indicating the second plurality of markets.

2. The method of claim 1, wherein assigning each geographic identifier to the market from the second plurality of markets comprises:
determining, for each of the second plurality of markets, a primary local affiliate station for each of the plurality of national television networks; and
assigning each geographic identifier to the market having the greatest number of primary local affiliate stations in common.

3. The method of claim 1, further comprising:
receiving population data indicating a number of households or a number of people associated with each geographic identifier;
determining that a county is associated with a first geographic identifier assigned to a first market from the second plurality of markets and a second geographic identifier assigned to a second market from the second plurality of markets;
comparing population data associated with the first geographic identifier to population data associated with the second geographic identifier to determine that the second geographic identifier is associated with a greater number of households or a greater number of people than the first geographic identifier; and
re-assigning the first geographic identifier to the second market.

4. The method of claim 1, further comprising:
receiving population data indicating a number of households or a number of people associated with each geographic identifier;
determining that at least two markets from the second plurality of markets have the same primary local affiliate for a second subset of the plurality of national television networks, the second subset being smaller than the first subset;
determining that the at least two markets satisfy a population threshold or a geographic identifier threshold;
merging the at least two markets together to generate a third plurality of markets;
assigning each geographic identifier to a market from the third plurality of markets; and
outputting a report indicating the third plurality of markets.

5. The method of claim 4, wherein assigning each geographic identifier to the market from the third plurality of markets comprises:
determining, for each of the third plurality of markets, a primary local affiliate station for each of the plurality of national television networks; and
assigning each geographic identifier to the market having the greatest number of primary local affiliate stations in common.

6. The method of claim 4, further comprising:
determining that a county is associated with a first geographic identifier assigned to a first market from the third plurality of markets and a second geographic identifier assigned to a second market from the third plurality of markets;
comparing population data associated with the first geographic identifier to population data associated with the second geographic identifier to determine that the second geographic identifier is associated with a greater number of households or a greater number of people than the first geographic identifier; and
re-assigning the first geographic identifier to the second market.

7. The method of claim 4, wherein determining that the at least two markets satisfy the population threshold comprises:
identifying a plurality of geographic identifiers that have been assigned to the at least two markets;
determining, based on population data for the plurality of geographic identifiers, that a first geographic identifier from the plurality of geographic identifiers has a smaller number of households or a smaller number of people than a second geographic identifier from the plurality of geographic identifiers; and
determining that the first geographic identifier is associated with a number of households or a number of people below a predetermined threshold.

8. The method of claim 4, wherein determining that the at least two markets satisfy the geographic identifier threshold comprises determining that a single geographic identifier has been assigned to the at least two markets.

9. The method of claim 1, wherein the geographic identifiers include at least one of ZIP codes, area codes, latitude-longitude values, city names, neighborhood names, county names, or census designated places.

10. The method of claim 1, wherein the geographic identifiers are each associated with a geographic boundary that defines the geographic area.

11. The method of claim 1, wherein determining the primary local affiliate station for each of the plurality of national television network comprises:
matching, for each geographic identifier, a local affiliate station that is carried by a majority of headends associated with the geographic identifier to each of the plurality of national television networks.

12. The method of claim 11, wherein the headends associated with each geographic identifier comprise at least one of an over-the-air (OTA) headend, a cable television headend, or a direct broadcast satellite (DB S) headend.

13. The method of claim 1, further comprising:
receiving population data indicating a number of households or a number of people associated with the at least two markets; and
comparing population data associated with a first market from the at least two markets to population data associated with a second market from the at least two markets to determine that the second market is associated with a greater number of households or a greater number of people than the first market.

14. The method of claim 13, wherein merging the at least two markets together to generate the second plurality of markets comprises merging the first market into the second market.

15. The method of claim 13, wherein determining that the at least two markets have the same primary local affiliate for the first subset of the plurality of national television networks comprises:
determining that a third market from the at least two markets and the first market have the same primary local affiliate for the first subset of the plurality of national television networks;
determining that the third market and the second market have the same primary local affiliate for the first subset of the plurality of national television networks; and
determining that the first market and the second market do not have the same primary local affiliate for the first subset of the plurality of national television networks.

16. The method of claim 15, wherein merging the at least two markets together to generate the second plurality of markets comprises merging the third market into the second market.

17. A method comprising:
receiving geographic identifiers each indicating a geographic area;
receiving television network affiliate data indicating local affiliate stations for a plurality of national television networks;
determining, for each geographic identifier, a primary local affiliate station for each of the plurality of national television networks;
grouping, into a first plurality of markets, the geographic identifiers that have the same primary local affiliate for each of the plurality of national television networks;
determining that at least two markets from the first plurality of markets have the same primary local affiliate for a first subset of the plurality of national television networks;
merging the at least two markets together to generate a second plurality of markets;
receiving population data indicating a number of households or a number of people associated with each geographic identifier;
determining that at least two markets from the second plurality of markets have the same primary local affiliate for a second subset of the plurality of national television networks, the second subset being smaller than the first subset;
merging the at least two markets together to generate a third plurality of markets;
assigning each geographic identifier to a market from the third plurality of markets; and
outputting a report indicating the third plurality of markets.

18. The method of claim 17, further comprising, before merging the at least two markets together to generate the third plurality of markets:
determining that the at least two markets satisfy a population threshold or a geographic identifier threshold.

19. The method of claim 17, further comprising;
determining that a county is associated with a first geographic identifier assigned to a first market from the third plurality of markets and a second geographic identifier assigned to a second market from the third plurality of markets;
comparing population data associated with the first geographic identifier to population data associated with the second geographic identifier to determine that the second geographic identifier is associated with a greater number of households or a greater number of people than the first geographic identifier; and
re-assigning the first geographic identifier to the second market.

20. A system comprising:
at least one processor; and
at least one memory storing instructions that, when executed, cause the at least one processor to:
receive geographic identifiers each indicating a geographic area;
receiving television network affiliate data indicating local affiliate stations for a plurality of national television networks;
determine, for each geographic identifier, a primary local affiliate station for each of the plurality of national television networks;
group, into a first plurality of markets, the geographic identifiers that have the same primary local affiliate for each of the plurality of national television networks;
determine that at least two markets from the first plurality of markets have the same primary local affiliate for a first subset of the plurality of national television networks;
merge the at least two markets together to generate a second plurality of markets;
assign each geographic identifier to a market from the second plurality of markets; and
output a report indicating the second plurality of markets.
